(19) United States
(12) Patent Application Publication
(10) Pub. No.: US 2003/0204435 A1
(43) Pub. Date: Oct. 30, 2003

(54) Direct collection of customer intentions for designing customer service center interface

(75) Inventors: Meredith L. McQuilkin, Austin, TX (US); Gregory W. Edwards, Austin, TX (US); Kurt M. Joseph, Austin, TX (US); Benjamin A. Knott, Round Rock, TX (US); John M. Martin, Austin, TX (US); Robert R. Bushey, Cedar Park, TX (US)

Correspondence Address: BAKER BOTTS L.L.P., PATENT DEPARTMENT, 98 SAN JACINTO BLVD., SUITE 1500, AUSTIN, TX, 78701-4039, US

(73) Assignee: SBC Technology Resources, Inc., Austin, TX

(21) Appl. No.: 10/135,460

(22) Filed: Apr. 30, 2002

(51) Int. Cl. G06F 17/60

(52) U.S. Cl. 705/10

(57) ABSTRACT

A method of collecting customer intentions of customers who use automated service systems, such as web-based or interactive telephone-based service applications. Customers are surveyed when they use the application to collect their intention in visiting the system. The responses of these customers are collected and tabulated. The relative frequencies of customer intentions are analyzed and used to design an interface to the service application, so that future customers will be presented with menu-type selections that best reflect their needs.

### TECHNICAL FIELD OF THE INVENTION

This invention relates to automated customer service systems and methods, and more particularly to a method for collecting the intentions of customers who use automated customer service systems, such as IVRs and websites.

### BACKGROUND OF THE INVENTION

Automated customer service systems, such as interactive voice response systems and web sites, that provide customer service functions are important to many organizations. These automated systems are designed so that customers may accomplish tasks that would otherwise require a customer service agent. The use of these systems can be used non-stop greatly increasing convenience while reducing time and costs for both agents and customers. The user interface must be easy and useful for customers to use an automated system.

### BRIEF DESCRIPTION OF THE DRAWINGS

FIG. 1 illustrates a first example of a means for collecting customer intentions, a customer call log sheet.

FIG. 2 illustrates a second example of a means for collecting customer intentions, an open-ended web survey page.

FIG. 3 illustrates a third example of a means for collecting customer intentions, a web survey page that displays both selectable choices and an open-ended dialog box.

FIG. 4 illustrates an example of a customer intention database, which stores one or more frequency records.

FIG. 5 illustrates an example of how customer responses to surveys may be categorized by style.

FIG. 6 illustrates a subset of a customer statement categorization list.

### DETAILED DESCRIPTION OF THE INVENTION

The following description is directed to designing an automated customer service system to maximize its usefulness to the customer. A precept of this usefulness is the recognition that a first step in designing an effective customer service interface is understanding the customer intentions, or in other words, what customers want to accomplish. The customer service site for which the interface is to be designed may be a telephone center, web site, or some combination of the two. The site may rely on voice entry, keypad entry, keyboard entry, or some combination of these.

As explained below, the method described herein permits designers of customer service interfaces to design from the perspective of the customer rather than that of the service provider. Based on the new design, the customer may then be routed to the most appropriate Internet location (for web-based service centers) or agent (for telephone-based service centers), where any customer can accomplish his or her desired task with maximum satisfaction and minimum cost to the service provider.

Customer intentions may vary widely. For example, a customer's intention may be to gather information, schedule a visit, or purchase an item. Knowing what these intentions are and how they vary permits designers to focus on the critically important aspects of an interface, from the customer's perspective.

As explained below, customer intentions are best understood by examining the type and frequency of requested tasks. If the frequency is determined, the more frequently used tasks can be included as an integral part of the interface. Less frequent tasks are minimized in the design.

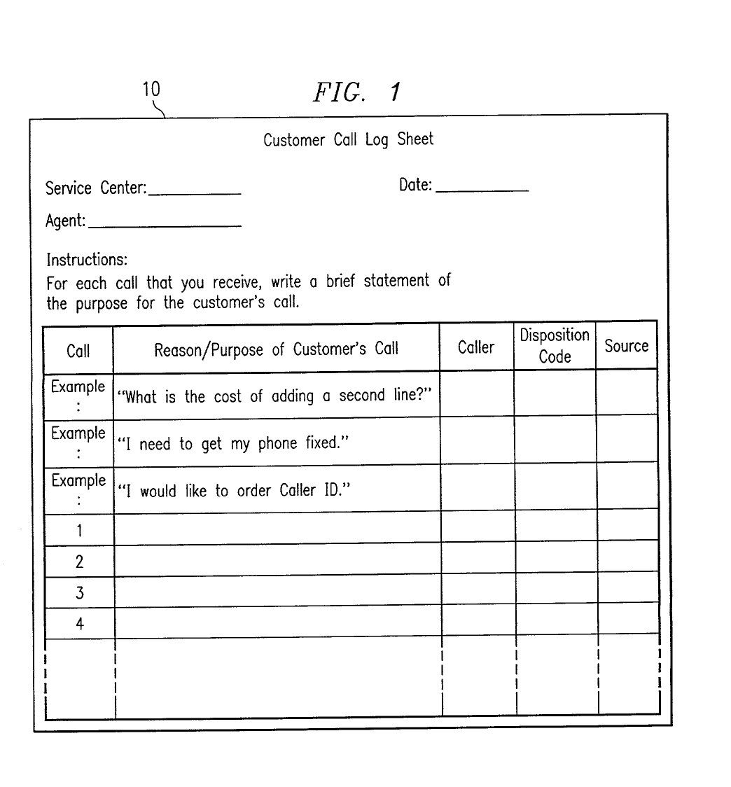

FIGS. 1-3 illustrate three examples of methods for collecting customer intentions. For purposes of example only, these methods reflect customer service applications for a telephone service provider, but the same concepts could be applied to any service provider.

A common feature of each method is that customer intentions are collected directly from the customer. In this respect, each method represents a variation of a “survey” approach to collecting customer intentions. The intentions are gathered explicitly rather than inferred, as would be the case if customer intentions were inferred from clickstreams or web page hit lists.

These examples illustrate both “open-ended” and fixed-alternative collection techniques. An advantage of open-ended techniques is that they ensure non-biased responses in the customer's own words. An advantage of fixed alternative techniques is that they tend to place less demand on the customer and permit responses to be more easily analyzed.

FIG. 1 illustrates a first example of a means for collecting customer intentions, a customer call log sheet 10. Log sheet 10 would typically be used by a live operator of an interactive voice (telephone-based) customer service center.

Log sheet 10 could be presented by various means, such as by being printed on paper or by being displayed on a computer screen. It is anticipated that telephone-based customer service applications in the future may permit interactive service via a computer screen.

A service agent at a customer call center maintains log sheet 10. When a customer calls the center for service, the customer is prompted to provide an “opening statement”, which represents the task the customer desires to accomplish during the call. The service agent is instructed to fill in the actual words that the customer uses, not terminology of the service provider. Other information, such as the type of caller, disposition of the call, or the caller's number may also be filled in.

During a course of time, the service agent records an opening statement for a number of customers. This data collection could also be done by parsing opening statements collected by voice recordings. These recordings could be parsed by speech recognition software to develop a frequency table, as discussed below.

As indicated in FIG. 1, the type of opening statements that may be recorded are open-ended. As explained below, once a number of statements are recorded, they are categorized and the frequency of each type of call is determined.

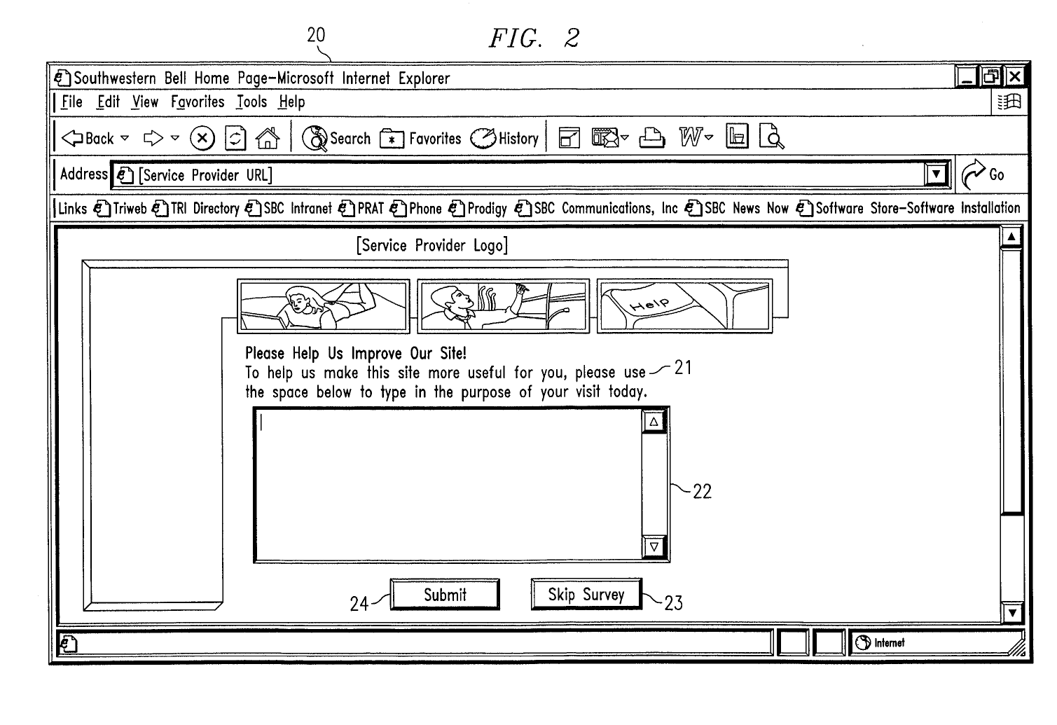

FIG. 2 illustrates a second example of a means for collecting customer intentions, an open-ended web survey page 20. Survey page 20 is presented on a customer's computer screen in response to the customer entering a web address for the service provider via a web browser. As indicated in FIG. 2, a conventional web browser may be used.

Using survey page 20, customer intent is solicited by prompting the customer to enter his or her reason for visiting the company's web site. Any type of prompt, such as prompt 21, may be used. The customer enters the response in dialog box 22.

Like the example of FIG. 1, survey page 20 is “open-ended”. Typically, page 20 is presented at the beginning of the customer's foray at the web site, but it may appear at any point. If desired, each customer's navigation through the web site may be tracked. Various navigation tracking techniques may be used, an example being click-stream tracking. The tracking is used to corroborate the customer's survey response in dialog box 22. The customer submits the response with button 24 and may skip the survey by clicking on button 23.

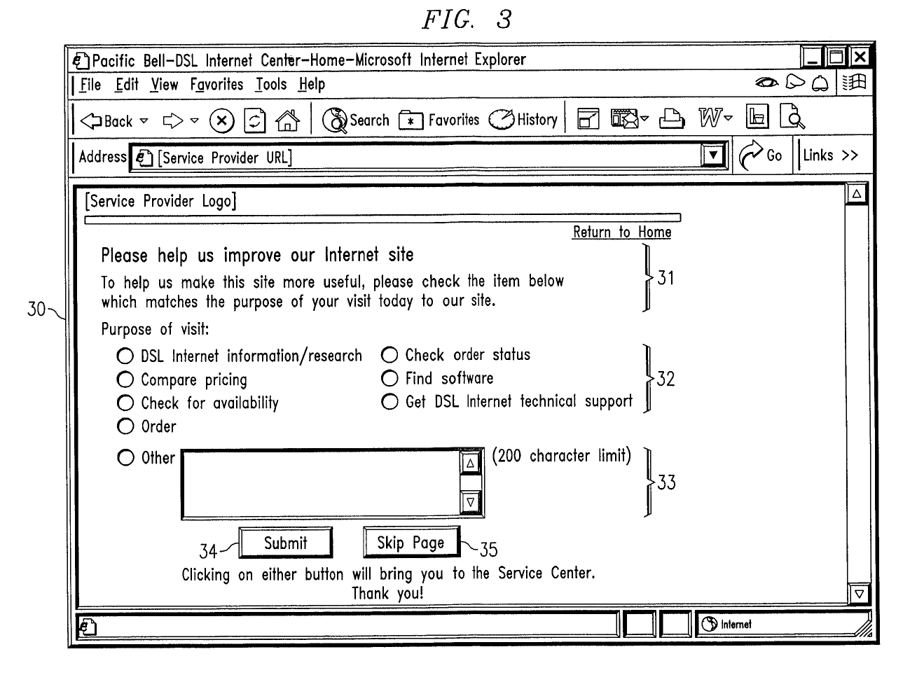

FIG. 3 illustrates a third example of a means for collecting customer intentions, a web survey page 30. In contrast to page 20, page 30 displays both selectable choices and an open-ended dialog box 33.

Using survey page 30, customer intent is solicited using an on-line survey form that asks customers to select from a limited number of choices, each reflecting a different possible customer intention. Prompt 31 requests the customer to select a choice. The customer is presented with a list of selections 32, as well as a dialog box 33 in which additional intentions may be described.

In addition to the examples of FIGS. 1-3, various other survey types could be used, with the common feature being that the customer's intentions are stated in the customer's own words. In the example of FIG. 3, the customer is presented with choices, and it is assumed that if a choice does not exactly match what the customer would state, the customer will fill in the dialog box 33.

Each of the surveys of FIGS. 1-3 is presented to the customer upon entry to the customer service application. In the case of a web-based service center, “cookie” type programming is used to control the presentation (recorded or displayed) of the survey to the customer. For example, in a web based customer service center, the display is presented upon the customer's entry to the web site, and only once for each visit. Only if the customer closes the customer's web browser or returns after a specified time, such as 24 hours, is the survey re-displayed.

The web-based surveys of FIGS. 2 and 3 include a “click through” option, buttons 22 and 33, which permit the customer to continue the visit to the site without answering the survey. For the telephone center survey of FIG. 1, an opt out option could be similarly offered by the service agent.

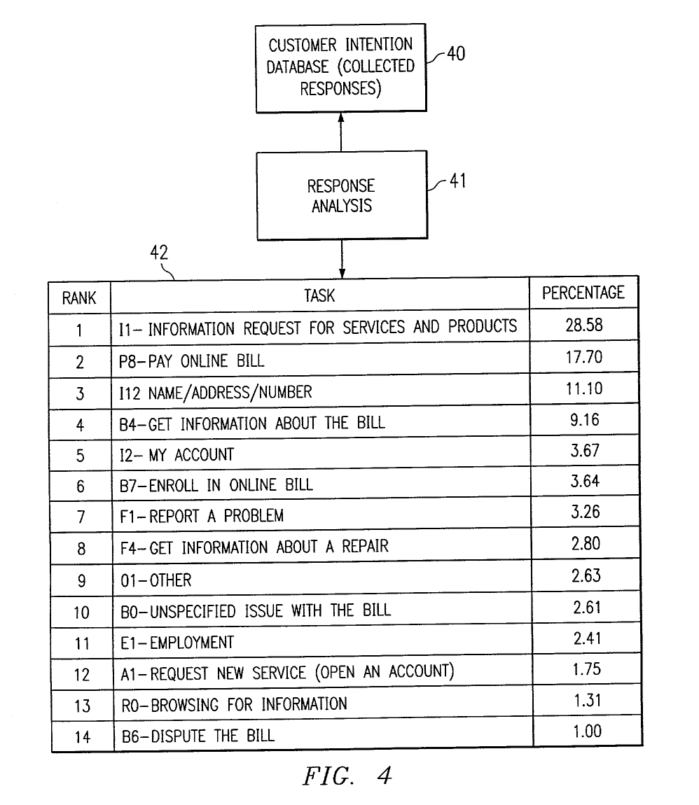

As indicated in FIG. 4, regardless of the means for collecting customer intentions, the responses are written to a database 40 for later analysis. A sufficiently large sample is collected so as to create a useful frequency table. It is expected that at least 2000 responses would be collected.

FIG. 4 further illustrates an example of a frequency record, here in the form of a table 42. Table 42 is compiled after customer responses are collected, categorized, counted, and tabulated. The raw response data is collected in a database 40. An analysis process 41 catagorizes the responses and calculates frequencies to produce Table 42. In the example of FIG. 4, customer intentions are arranged in descending order. Frequency is calculated as a ratio relative to total responses.

Once the variation and frequency of customer intentions is known, this information can be incorporated into the design of an automated customer system. This aspect of incorporating user intentions into the design process to match customer needs will result in better interface design and higher system utilization. Menu items are made to directly match tasks that customers desire to accomplish. Menu items are grouped and ordered by frequency of the associated task. Menu items are worded in the language of the customer.

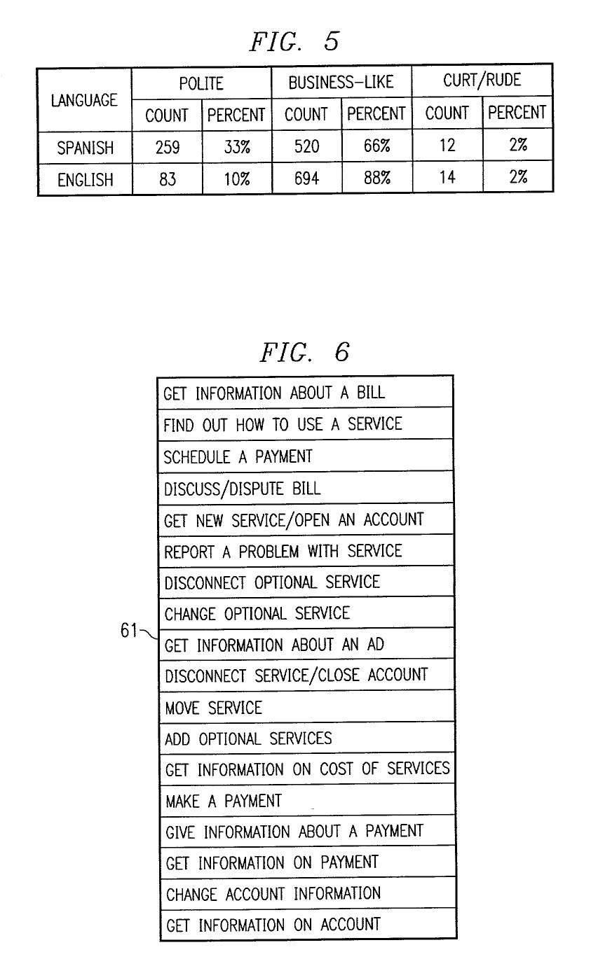

FIG. 5 illustrates an example of how customer responses may be categorized by style. In the example of FIG. 5, responses have been analyzed in terms of their level of “politeness”. This analysis can be used to determine the formality of task descriptions in the customer service interface. Responses are also categorized into the language spoken by the customer.

FIG. 6 illustrates a portion of a web-based customer service interface, specifically, a selection list 61 of customer tasks. These selections correspond to responses made by actual customers, such as to one of the surveys of FIGS. 1-3, and are arranged in order of frequency. In this example, the customer may select any of the services by clicking on the description. Selection list 61 can be used to re-design websites. It is entirely possible that web pages could be re-designed “on the fly” to meet customer intentions. A telephone-based service center uses survey responses in a similar manner, such as by identifying and arranging automated menu selections so that they correspond to customer intentions.

In some cases, it may happen that customers desire services or information that are not supported on the website. For example, customers may want information that is not available on the website, but for which a link to another website can be provided. The frequency data of FIG. 4 will reveal that a link to that other site should be included by the service provider.

The frequency table 42 may reveal the existence of “meta” categories of services. For example, the table may reveal that customers use the website for information gathering, pricing inquiries, and answers to technical questions. This information can determine the layout of the website, and enable the service provider to make those services easily accessible, such as by menu selections, buttons, tabs, or other clickable access means. Furthermore, once a meta category is recognized, further analysis can be used to provide additional information. For example, customers may be interviewed or their emails to the service provider may be categorized.

The content, as well as the organization of the website, can be designed better in light of frequency table 42. If desired, the categorization of customer intentions can be performed by the customers themselves. A set of customers is provided with a set of customer intentions and asked to categorize them into logical groups. Categories are ranked in order of importance. Category descriptions in the interface are labeled in the same terminology as used by the customers. For example, frequency table 42 might indicate that “get information” is a frequent meta category. Specific tasks within the frequency table might be “get information about account”, “get information about services” and “get information about prices”. The resulting menu item would be labeled “To get information about your account, or our services and prices, press 1”. For a web-based site rather than a telephone-based site, the customer would be asked to click a menu tab or button.

Other Embodiments

Although the present invention has been described in detail, it should be understood that various changes, substitutions, and alterations can be made hereto without departing from the spirit and scope of the invention as defined by the appended claims.

What is claimed is:

1. A method of designing a customer service interface for a web-based customer service site, comprising the steps of:
presenting each customer with a survey page upon entry to the site, wherein the survey page contains at least a dialog box;
prompting each customer to enter a description of the customer's reason for visiting the site;
receiving a number of responses to the prompting step;
categorizing the responses into a set of customer intention categories;
counting the number of responses in each category;
calculating a frequency value associated with each category, the frequency value for each category representing the number of times a response is made for that category relative to other categories;
providing selections for the web site based on the results of the calculating step, wherein the selections are described in language corresponding to the customer responses and wherein the selections are ordered by frequency value; and
providing at least one hypertext link to another web page based on the results of the collecting step.

2. A method of designing a customer service interface for a web-based customer service site, comprising the steps of:
presenting each customer with a survey page upon entry to the site;
prompting each customer to enter a description of the customer's reason for visiting the site;
receiving a number of responses to the prompting step;
categorizing the responses into a set of customer intention categories;
counting the number of responses in each category;
calculating a frequency value associated with each category, the frequency value for each category representing the number of times a response is made for that category relative to other categories; and
providing selections for the web site based on the results of the calculating step, wherein the selections are described in language corresponding to the customer responses.

3. The method of claim 2, wherein the survey page has a click through means for permitting the receiving step to be bypassed.

4. The method of claim 2, further comprising the step of providing programming operable to control the number of times the presenting step is performed for a particular customer.

5. The method of claim 2, further comprising the step of providing at least one link to another web page based on the results of the collecting step.

6. The method of claim 2, wherein the providing step is performed such that selections are ordered in order of frequency.

7. The method of claim 2, wherein the survey page contains a dialog box and the customer enters the responses into the dialog box.

8. The method of claim 2, wherein the survey page contains a selection list and the customer selects from that list.

9. The method of claim 2, wherein the survey page contains both dialog box into which customers may enter responses and a selection list from which customers may select.

10. The method of claim 2, further comprising the step of corroborating the responses by tracking a customer's navigation through the web site.

11. A method of designing a customer service interface for an interactive telephone-based customer service center, comprising the steps of:
presenting each customer with a survey page upon entry to the center;
prompting each customer to state a description of the customer's reason for visiting the site;
receiving a number of responses to the prompting step;
categorizing the responses into a set of customer intention categories;
counting the number of responses in each category;
calculating a frequency value associated with each category, the frequency value for each category representing the number of times a response is made for that category relative to other categories; and
providing selections for the service center based on the results of the calculating step, wherein the selections are described in language corresponding to the customer responses.

12. The method of claim 11, wherein the providing step is performed such that selections are ordered in order of frequency.

13. The method of claim 11, wherein the receiving step is performed by a live service agent.

14. The method of claim 11, wherein the receiving step is performed by a voice recording device.

15. The method of claim 14, further comprising the step of parsing the responses.
